(19) United States
(12) Patent Application Publication
(10) Pub. No.: US 2026/0299193 A1
(43) Pub. Date: Oct. 1, 2026

(54) HOLLOW CORE VERTICAL WAVEGUIDES FOR PHOTONIC INTERCONNECTS AND ROUTING FABRICS

(71) Applicant: University of Florida Research Foundation, Incorporated, Gainesville, FL (US)

(72) Inventors: Volker J. Sorger, Gainesville, FL (US); Hangbo Yang, Gainesville, FL (US); Md. Mahfuzur Rahman, Gainesville, FL (US)

(21) Appl. No.: 19/563,126

(22) Filed: Mar. 11, 2026

Related U.S. Application Data
(60) Provisional application No. 63/780,669, filed on Mar. 31, 2025.

(51) Int. Cl. G02B 6/12; G02B 6/13

(52) U.S. Cl. CPC G02B 6/12002

(57) ABSTRACT

Methods and apparatuses are provided for hollow core vertical waveguides (HCVWs) for 3D photonic routing fabrics. In the context of an apparatus, the apparatus comprises an in-plane waveguide, an HCVW comprising an out-of-plane waveguide and hollow cores, and an interface coupled with the in-plane waveguide, wherein the interface is configured to transfer light between the in-plane waveguide and the out-of-plane waveguide.

### CROSS-REFERENCE TO RELATED APPLICATIONS

This application claims the benefit of priority to U.S. Provisional Application No. 63/780,669, filed Mar. 31, 2025, which is herein incorporated by reference in its entirety for all purposes.

### TECHNICAL FIELD

Various embodiments of the present disclosure relate to photonic integrated circuits (PICs) and, more particularly, to hollow core vertical waveguides (HCVWs) for photonic interconnects and routing fabrics.

### BACKGROUND

Rapid advancement of high-performance computing (HPC) and artificial intelligence (AI) applications, particularly in machine learning (ML) and deep learning (DL), has led to an exponential increase in the demand for high-bandwidth, low-latency, and energy-efficient communication between processing cores on a chip. The capabilities of traditional electrical interconnects may fail to keep pace with such demands due to their limited bandwidth, high latency, and significant power consumption. Notably, much of the compute performance gains in graphics processing units (GPUs) over the past decade were based on non-field-effect transistor (non-FET) scaling improvements. Thus, there is a need to facilitate additional AI and HPC gains by improving chip packaging, architecture, and three-dimensional (3D) heterogenous integration of electronic and photonic chips alike.

### BRIEF SUMMARY

The present disclosure provides methods and apparatuses for reducing insertion loss and cross talk for photonic interconnects and 3D photonic routing fabrics using HCVWs. The HCVWs provide for efficient light transfer and reduced crosstalk in high-density photonic interconnects. By using HCVWs, the methods and apparatuses provide for low-loss, high-efficiency 3D photonic routing for PICs.

In at least one example embodiment, an apparatus is provided comprising: an in-plane waveguide; a hollow-core-vertical-waveguide (HCVW) comprising an out-of-plane waveguide and hollow cores; and an interface coupled with the in-plane waveguide, wherein the interface is configured to transfer light between the in-plane waveguide and the out-of-plane waveguide.

In at least one example embodiment, the in-plane waveguide is configured for horizontal light propagation and the out-of-plane waveguide is configured for vertical light propagation, and wherein the out-of-plane waveguide is positioned vertically above or below the in-plane waveguide.

In at least one example embodiment, the hollow cores are oriented along the same plane as the out-of-plane waveguide, and wherein the hollow cores are positioned around the out-of-plane waveguide.

In at least one example embodiment, the HCVW is one of a plurality of HCVWs within an array, and wherein the pitch of the array is based at least in part on a diameter of the hollow cores.

In at least one example embodiment, the apparatus further comprises at least one other hollow core positioned in between the HCVW and a second HCVW of the array, wherein the pitch is based at least in part on the diameter of the at least one other hollow core.

In at least one example embodiment, the diameter of the at least one other hollow core is different from the diameter of the hollow cores.

In at least one example embodiment, the pitch is greater than about 1 micron.

In at least one example embodiment, the hollow cores comprise air, silicon oxide, or another material with a refractive index that is lower that the refractive index of the HCVW.

In at least one example embodiment, the in-plane waveguide comprises a material selected from the group consisting of: a crystalline silicon material, a silicon nitride material, a material comprising a group III element and a group V element, an oxide material, a polymer material, and a combination thereof.

In at least one example embodiment, the out-of-plane waveguide comprises a material selected from the group consisting of: an amorphous silicon material, a crystalline silicon material, a silicon nitride material, a material comprising a group III element and a group V element, an oxide material, and a combination thereof.

In at least one example embodiment, the interface comprises a flat surface or a concave surface of the in-plane waveguide.

In at least one example embodiment, an insertion loss and mode alignment associated with the apparatus is based at least in part on an angle of the flat surface or a curvature of the concave surface.

In at least one example embodiment, the interface comprises a reflective layer.

In at least one example embodiment, the interface further comprises an air gap positioned below the reflective layer.

In at least one example embodiment, the apparatus comprises a photonic interconnect or routing fabric.

In at least one example embodiment, a method for fabricating an apparatus in accordance with a fabrication process is provided, wherein the fabrication process comprises forming the interface in the in-plane waveguide using wet etching, dry etching, or gray scale lithography.

In at least one example embodiment, the fabrication process comprises forming the interface in the in-plane waveguide via the wet etching or the dry etching to obtain a flat surface.

In at least one example embodiment, the fabrication process comprises forming the interface in the in-plane waveguide via the gray scale lithography to obtain a concave surface.

In at least one example embodiment, the fabrication process further comprises fabricating the HCVW via a deep etching process, and wherein the deep etching process comprises dry deep etching or wet deep etching.

In at least one example embodiment, the fabrication process further comprises fabricating the in-plane waveguide via an etching process, and wherein the etching process comprises dry etching or wet etching.

The above summary is provided merely for purposes of summarizing at least some example embodiments to provide a basic understanding of some aspects of the disclosure. Accordingly, it will be appreciated that the above-described embodiments are merely examples and should not be construed to narrow the scope of the disclosure in any way. It will also be appreciated that the scope of the disclosure encompasses many potential embodiments in addition to those summarized here, some of which will be further described below.

The above summary is provided merely for purposes of summarizing at least some example embodiments to provide a basic understanding of some aspects of the disclosure. Accordingly, it will be appreciated that the above-described embodiments are merely examples and should not be construed to narrow the scope of the disclosure in any way. It will also be appreciated that the scope of the disclosure encompasses many potential embodiments in addition to those summarized here, some of which will be further described below.

### BRIEF DESCRIPTION OF THE DRAWINGS

Embodiments incorporating teachings of the present disclosure are shown and described with respect to the figures presented herein.

FIGS. 1A and 1B illustrate schematic diagrams of an example waveguide structure in accordance with some embodiments of the present disclosure;

FIGS. 2A and 2B illustrate example electric-field (E-field) cross-section simulation results in accordance with some embodiments of the present disclosure;

FIGS. 2C and 2D illustrate example E-field profile simulation results in accordance with some embodiments of the present disclosure;

FIG. 3A illustrates an example 3D schematic diagram of an HCVW in accordance with some embodiments of the present disclosure;

FIG. 3B illustrates example simulation results in accordance with some embodiments of the present disclosure;

FIG. 3C illustrates example E-field cross-section simulation results in accordance with some embodiments of the present disclosure;

FIG. 4A illustrates an example 3D schematic diagram of an HCVW in accordance with some embodiments of the present disclosure;

FIG. 4B illustrates example simulation results in accordance with some embodiments of the present disclosure;

FIG. 4C illustrates example E-field cross-section simulation results in accordance with some embodiments of the present disclosure;

FIG. 5A illustrates an example schematic diagram of a hybrid HCVW structure integrated with nano-mirror couplers (NMCs);

FIG. 5B illustrates an example diagram of E-field cross-section simulation results in accordance with some embodiments of the present disclosure;

FIG. 5C illustrates an example 3D schematic diagram of a hybrid HCVW structure integrated with NMCs;

FIG. 6A illustrates an example 3D schematic diagram of integrated HCVW architectures in accordance with some embodiments of the present disclosure;

FIG. 6B illustrates example simulation results in accordance with some embodiments of the present disclosure;

FIG. 6C illustrates example E-field cross-section simulation results in accordance with some embodiments of the present disclosure;

FIG. 6D illustrates an example 3D schematic diagram of integrated HCVW architectures in accordance with some embodiments of the present disclosure;

FIG. 6E illustrates example simulation results in accordance with some embodiments of the present disclosure;

FIG. 6F illustrates example E-field cross-section simulation results in accordance with some embodiments of the present disclosure; and

FIG. 7 illustrates an example diagram of a sensitivity analysis of an integrated coupler.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like, generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded. The term “or” is used herein in both the alternative and conjunctive sense, unless otherwise indicated.

### General Overview

Automation and intelligent computing, including AI and ML business products, have become an economic driver for many corporations. The increase in AI and ML business products parallels a demand for data center unit (DCU) expansions. To accommodate for such compute and AI demands, there is a need for improved device, chip, package, supply chain, and ecosystem approaches. Notably, much of the compute performance gains in GPU technologies over the past decade were based on non-FET scaling improvements. To achieve additional AI and HPC gains, improvements in chip packaging, architecture, 3D heterogenous integration of electronic and photonic chips are needed. For example, the rapid advancement of HPC and AI applications, particularly in ML and DL, has led to an exponential increase in the demand for high-bandwidth, low-latency, and energy-efficient communication between processing cores on a chip. Traditional electrical interconnects may fail to keep up with such demands due to electrical interconnects being associated with a constrained bandwidth, high latency, and substantial power consumption.

Some PIC designs face challenges in transferring light between stacked layers in 3D photonic systems. For example, such PIC designs may employ coupling methods, such as grating couplers and directional couplers, that suffer from relatively high insertion loss, constrained scalability, and substantial crosstalk. The crosstalk experienced due to such coupling methods may be exacerbated in densely packed systems with a relatively small waveguide pitch (e.g., less than about 1 micron (μm)). Additionally, some such PICs designs rely on solid-core waveguides or hybrid bonding techniques that restrict fabrication precision, optical loss, and integration density. The inability to suppress crosstalk in dense waveguide configurations reduces the performance of PICs, such as large-scale 3D photonic circuits. Further, some PIC designs may employ silicon nitride-based waveguides and solid-core designs with embedded couplers, which may result in relatively large footprints and/or excessive optical losses. Consequently, such PIC designs may fail to meet stringent insertion loss and crosstalk suppression constraints imposed by next-generation 3D PICs.

Various aspects of the present disclosure provide for HCVWs to enable ultra-low-loss and low-crosstalk light coupling for 3D photonic routing fabrics. By leveraging hollow core geometries and relatively large air core designs, the HCVWs of the present disclosure achieve insertion losses as low as about 1.3 decibels/millimeter (dB/mm) while reducing crosstalk to below about −20 dB between neighboring HCVWs for densely packed interconnects. That is, various aspects of the present disclosure provide for HCVWs with relatively large air-filled cores between adjacent optical paths (e.g., even with a 3 μm pitch), which lead to low insertion loss (e.g., ultra-low insertion loss) and crosstalk reduction, thereby enabling efficient 3D photonic routing fabrics. In accordance with various aspects of the present disclosure, the HCVWs provide a scalable and compact solution for next-generation photonic signal routing platforms, including high-density optical interconnects such as for AI computer hardware in datacenters or signal off-take from network-edge camera systems.

### Exemplary Apparatuses and Methods

Various aspects of the present disclosure provide for HCVWs for photonic interconnects and routing fabrics. For example, various aspects of the present disclosure provide for a waveguide structure including one or more horizontal waveguides, one or more couplers (e.g., nano-mirror couplers (NMCs)), and one or more HCVWs. In some examples, the horizontal waveguide(s) may include crystalline silicon with a rectangular cross-section. In some such examples, the horizontal waveguide(s) provide efficient mode matching. The nano-mirror coupler(s) may be configured with a tilted design utilizing air and/or silicon oxide (SiO₂) reflective layers, which may provide for improved light coupling and stability. The HCVW(s) may include one or more high-index materials, such as silicon (Si), silicon nitride (SiNx), or a III-V semiconducting material, and may incorporate relatively large air and/or silicon oxide (SiO₂) cores to reduce (e.g., minimize) crosstalk and optical loss. In other words, the HCVWs may include a vertical waveguide integrated with multiple hollow cores (e.g., formed from air and/or SiO₂), which reduce optical losses and crosstalk between adjacent waveguides.

In some examples, direct bonding of horizontal and vertical waveguides, such as crystalline silicon vertical waveguides (with or without a thin oxide interlayer), may be used for enhanced optical performance and robustness. For example, a waveguide structure including such waveguides may achieve an insertion loss of about 1.3 dB/mm across a broadband range of about 1.5 μm to about 1.6 μm. As used herein, insertion loss refers to the loss of signal power (in dB) from the insertion of a crossing from an input port to one or more output ports. As used herein, the crossing refers to a point at which two waveguides intersect each other. In some examples, the crossing provides a path for the optical signal to propagate from one waveguide to another. In some examples, the inclusion of a (large) air core between adjacent optical paths further reduces crosstalk to below about −20 dB. Accordingly, one or more waveguide structures described herein may be suitable for high-density photonic interconnects and routing fabrics.

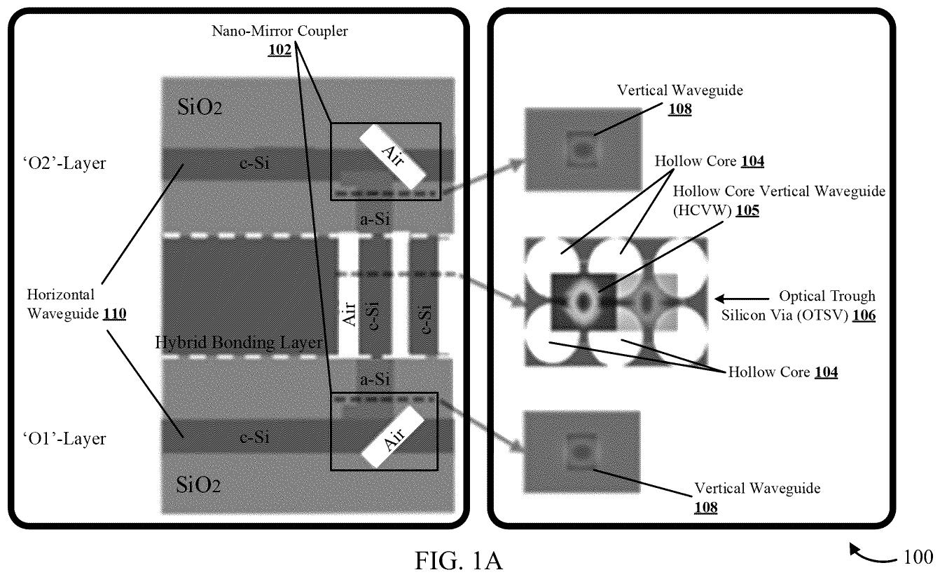

FIGS. 1A and 1B illustrate schematic diagrams of an example waveguide structure 100 in accordance with some embodiments of the present disclosure. The waveguide structure 100 may be used in photonic interconnects or routing fabrics. The waveguide structure 100 may include one or more in-plane waveguides (e.g., horizontal waveguides) with hybrid bonding. In the example of FIG. 1A, the waveguide structure 100 includes horizontal waveguides 110 and hybrid bonding layers. As used herein, hybrid bonding refers to a technique in which two waveguide components, which may be made of different materials, are joined together. In some examples, the two waveguide components may be joined together by combining a dielectric bond (e.g., silicon oxide) with embedded metal (e.g., copper). Hybrid bonding may provide for high-density electrical connections between different waveguide components while maintaining optical signal transmission through a waveguide structure including the different components.

The waveguide structure 100 also includes an HCVW 105, including a vertical waveguide (e.g., an out-of-plane waveguide forming an optical path) and hollow cores 104. As illustrated in the example of FIG. 1A, the HCVW 105 may be formed with crystalline Si (c-Si) integrated with air-filled cores. Although the example of FIG. 1A illustrates the HCVW 105 as being formed with c-Si, the HCVW 105 may be made from c-Si, amorphous Si (a-Si), SiNx, or a III-V material with integrated air-filled or SiO₂-filled cores (e.g., the hollow cores 104) to reduce optical crosstalk and insertion loss. In some examples, an HCVW may be vertically aligned above or below a horizontal waveguide. For example, an in-plane waveguide may be configured for horizontal light propagation and an out-of-plane waveguide may be configured for vertical light propagation and, as such, the out-of-plane waveguide may be positioned vertically above or below the in-plane waveguide. As illustrated in the example of FIG. 1A, the HCVW 105 is vertically aligned in between the horizontal waveguides 110 (e.g., above one of the horizontal waveguides 110 and below the other of the horizontal waveguides 110).

As illustrated in the example of FIG. 1A, the horizontal waveguides 110 may have a rectangular shape and may be formed from c-Si. Although the example of FIG. 1A illustrates the horizontal waveguides 110 as being formed from c-Si, the horizontal waveguides 110 may be formed from another material suitable for horizontal light propagation, such as SiNx, a III-V semiconducting material (e.g., a semiconducting material including a group III element and a group V element), an oxide material, or a polymer material, among other examples. In other words, the waveguide structure 100 may include a first (horizontal) waveguide made from c-Si, SiNx, III-V, oxide, or polymer material for horizontal light propagation. Non-limiting examples of an oxide material include SiO₂, HfO₂, and Al₂O₃. Non-limiting examples of a polymer may include an ultraviolet (UV) curable (UV-curable) polymer (e.g., Su-8), a photopatternable epoxy material (e.g., EpoCore/EpoClad), a siloxane material, a fluoropolymer (e.g., Cytop), and a cyclic olefin copolymer (COC).

The horizontal waveguides 110 provide for improved optical performance and may be compatible with one or more types of nano-mirror couplers. That is, the horizontal waveguides 110 may be compatible with nano-mirror couplers, which may serve as lateral-to-vertical couplers (or horizontal-to-vertical couplers), facilitating light reflection and coupling between the horizontal waveguides 110 and one or more vertical waveguides. In other words, the waveguide structure 100 may include one or more lateral-to-vertical couplers and an example of a lateral-to-vertical coupler includes a nano-mirror coupler. As used herein, a nano-mirror coupler refers to an angled or concave interface integrated with a horizontal (e.g., lateral or in-plane) waveguide, facilitating light transfer and coupling between the horizontal waveguide and a vertical (e.g., out-of-plane) waveguide, such as a vertical hollow core waveguide.

As illustrated in the example of FIG. 1A, the waveguide structure 100 includes nano-mirror couplers 102, which connect the horizontal waveguides 110 and the HCVW 105. That is, the waveguide structure 100 includes interfaces (the nano-mirror couplers 102) coupled with the horizontal waveguides 110 (e.g., in-plane waveguides), in which the interfaces are configured to transfer light between the horizontal waveguides 110 and the HCVW 105. In other words, the nano-mirror couplers 102 may be examples of a low-loss, high-compact coupler that couples (e.g., efficiently couples) horizontal waveguides to vertical waveguides. In some examples, to achieve efficient coupling between the horizontal waveguides 110 and the HCVW 105, the vertical waveguides 108 may be integrated with the nano-mirror couplers 102. Although the example of FIG. 1A illustrates the vertical waveguides 108 as being formed from a-Si, the vertical waveguides may be made from c-Si, a-Si, and/or SiNx. Additionally, although the horizontal waveguides 110 are illustrated as being formed from c-Si, the horizontal waveguides 110 may be designed using crystalline silicon, amorphous silicon, and/or silicon nitride to achieve high optical performance while ensuring seamless compatibility with nano-mirror couplers. In some examples, the design of the nano-mirror couplers 102 may be configured (e.g., optimized) to enhance coupling efficiency, reduce device footprint, and support broadband operation for various applications, such as wavelength-division multiplexing (WDM) applications. As illustrated in the FIG. 1A, the nano-mirror couplers 102 may include air layers as a reflective materials. In some other examples, the nano-mirror couplers 102 may include SiO₂ layers as reflective materials. The configuration of the waveguide structure 100 provides for improved coupling efficiency and effective reflection of incident light.

The waveguide structure 100 may be achieved through one or more fabrication methodologies. For example, the nano-mirror couplers 102 may be formed using wet etching, dry etching, or gray scale lithography. In other words, the fabrication process comprises forming an interface in an in-plane waveguide using wet etching, dry etching, or gray scale lithography. That is, the nano-mirror couplers 102 may be flat or concave (e.g., with optimized curvatures and/or angles) and may be fabricated using ion beam etching or grayscale lithography to achieve ultra-low insertion loss and precise mode alignment between horizontal and vertical waveguides. The nano-mirror couplers 102 may be formed in the horizontal waveguides 110 via wet etching or the dry etching to obtain flat surfaces or via gray scale lithography to obtain concave surfaces. The angle and/or the curvature of the surfaces forming the nano-mirror couplers 102 may be tuned to reduce (e.g., optimize) the insertion loss and improve mode alignment between the horizontal waveguides 110 and the HCVW 105.

In some examples, the waveguide structure 100 may include a horizontal flat nano-mirror coupler with crystalline silicon. In such an example, the waveguide structure 100 may be fabricated using an ion beam etch (IBE) mill (e.g., a 4-wave IBE mill tilted at an angle, such as 45 degrees). The interface may be designed to achieve low loss even with the presence of an air gap. For example, the waveguide structure 100 may incorporate a crystalline silicon substrate and an air gap beneath the reflective layer to improve reflectivity. That is, the nano-mirror couplers 102 may include a flat surface or a concave surface of the horizontal waveguides 110, in which the interface comprises a reflective layer and an air gap may be positioned below (e.g., underneath) the reflective layer.

In some examples, the waveguide structure 100 includes a vertical waveguide with amorphous silicon (e.g., the vertical waveguides 108). In some such examples, fabrication of the waveguide structure 100 may include lithography using photon or electron beams and the reflective layer (of the nano-mirror couplers 102) may include amorphous silicon deposited on a crystalline silicon substrate. The crystalline silicon substrate may be tilted at 45 degrees (or another suitable angle) for improved light coupling. In some examples, the waveguide structure 100 may include HCVWs (e.g., the HCVW 105) with crystalline silicon. In some such examples, fabrication of the waveguide structure 100 may include deep reactive-ion etching through which one or more surfaces of the waveguide structure 100 may adopt a concave geometry. As used herein, deep etching (or deep reactive-ion etching) refers to a fabrication technique in which a portion of the cladding material of a waveguide is etched away, creating a deep trench or groove to alter the light confinement within the waveguide. The concave geometry may enhance mode confinement and further improve optical performance. In some examples, the fabrication process may include integrating the horizontal waveguides 110 and the HCVW 105 via deep etching and hybrid bonding.

As illustrated in the example of FIG. 1A, the HCVW 105 may be configured with multiple, vertically aligned hollow cores 104. That is, the hollow cores 104 may be aligned vertically (e.g., above at least one horizontal waveguide). The hollow cores may be made from air, silicon oxide, or another material with a refractive index that is lower that the refractive index of the HCVW 105. As illustrated in the example of FIG. 1A, the hollow cores 104 may be aligned vertically between two horizontal waveguides. The hollow cores 104 may be positioned (e.g., oriented) along the same plane as a vertical waveguide forming the optical path 103. For example, the HCVW 105 may include a low-loss, high-compact vertical waveguide (e.g., providing the optical path 103) for efficient vertical signal propagation, and may also include hollow cores 104 (e.g., hallow core geometries) with relatively large air core designs capable of achieving insertion losses as low as approximately 1.3 dB/mm, while reducing crosstalk to approximately below −20 dB (e.g., even in densely packed interconnects). In some examples, the waveguide structure 100 (or a device including the waveguide structure 100) may be equipped with an optical transceiver that is configured to send and receive optical signals through an optical through silicon via (OTSV) including one or multiple HCVWs. For example, the waveguide structure 100 may include an OTSV 106, which may be configured throughout the interior of a chip, thereby increasing (e.g., maximizing) interconnect density and flexibility. The OTSV 106 may include the HCVW 105. For example, the OTSV 106 may be configured with the hollow cores 104 and a vertical waveguide, connecting one or more processing cores to a three-dimensional optical redistribution layer (ORDL) via the nano-mirror couplers 102. The ORDLs may include horizontal optical layers (e.g., an ‘O1’ layer and an ‘O2’ layer) that facilitate communication between different processing cores.

In some examples, the hollow cores 104 may be engineered with relatively large air-filled cores positioned between adjacent optical paths (e.g., two adjacent vertical waveguides), which enables ultra-low optical loss while reducing (e.g., substantially reducing) crosstalk. In some examples, the HCVW 105 may include a vertical waveguide (e.g., an out-of-plane waveguide) with a relatively thin Si layer and a circular hollow core comprising four air-filled holes (e.g., the hollow cores 104). The circular geometry facilitates improved mode matching with vertical square waveguides, enabling efficient light transfer across layers (e.g., the ‘O1’ layer and the ‘O2’ layer). The (large) air core holes provide robust optical isolation, reducing crosstalk to below −20 dB (e.g., even for tightly packed waveguides with a pitch of about 1 μm). The waveguide structure 100 provides for a simplified fabrication process while maintaining mechanical stability during inter-layer transfer.

One or more packaging approaches may be used to integrate the (rectangular) horizontal waveguides 110 with the HCVW 105. For example, the horizontal waveguides 110 may be integrated with the HCVW 105 via an amorphous Si/SiNx transition layer with hybrid bonding. In such an example, a vertical waveguide layer including amorphous Si or SiNx (e.g., the vertical waveguides 108) may be formed to stabilize optical modes, followed by hybrid bonding with crystalline Si HCVWs (e.g., the HCVW 105). In some examples, an SiO₂ interlayer may be used to provide robust bonding and enhance optical mode confinement. The SiO₂ interlayer may have a thickness of about 50 nm or another suitable thickness.

In some examples, the horizontal waveguides 110 may be integrated with the HCVW 105 via direct hybrid bonding. In some such examples, horizontal crystalline Si waveguides may be directly bonded to the HCVW 105 with, for example, a 50 nm SiO₂ interlayer. In some examples, direct hybrid bonding may reduce (e.g., minimizes) fabrication complexity. In some other examples, the horizontal waveguides 110 may be integrated with the HCVW 105 via an amorphous Si/SiNx transition layer with direct hybrid bonding. In such examples, the SiO₂ interlayer may be excluded, which may increase the optical performance and simplify the fabrication process.

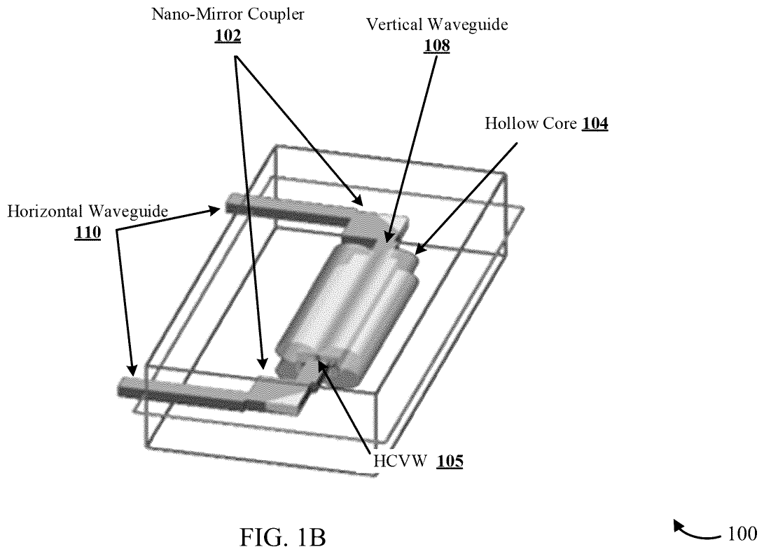

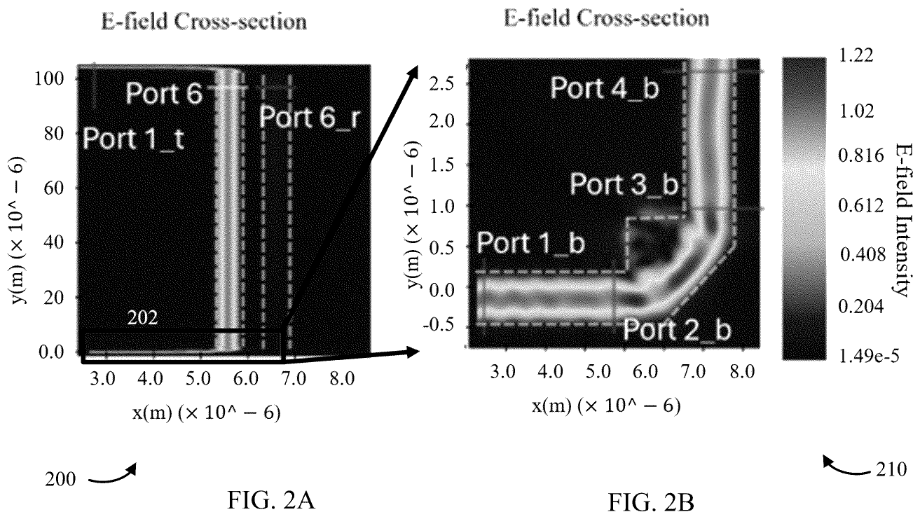

FIG. 2A illustrates example electric-field (E-field) cross-section simulation results 200 in accordance with some embodiments of the present disclosure. The example simulation results 200 are for a waveguide structure, such as a waveguide structure 100 illustrated by and described with reference to FIGS. 1A and 1B.

FIG. 2B illustrates example E-field cross-section simulation results 210 in accordance with some embodiments of the present disclosure. The example simulation results 210 correspond to a portion 202 of the simulation results 200 illustrated in the example of FIG. 2A. As used herein, ‘_r’ denotes the right side of a port, ‘_b’ denotes the bottom of the respective port, and ‘_t’ denotes the top of the respective port.

The example simulation results 200 and 210 illustrate the E-field transfer between Port 1_b and Port 1_t at 1550 nm. As illustrated in the example of FIG. 2A, an optical signal may be provided to a first (bottom) horizontal waveguide at Port 1_1b (e.g., an input port). The optical signal propagates through the first horizontal waveguide (and thus through Port 1_b) and is reflected by a first (bottom) nano-mirror coupler from the first horizontal waveguide to a vertical waveguide (e.g., an HCVW). The optical signal then propagates through the vertical waveguide (and thus through Port_6) and is reflected by a second (top) nano-mirror coupler from the vertical waveguide to a second (top) horizontal waveguide. The optical signal then propagates through the second horizontal waveguide toward port 1_t.

FIGS. 2C and 2D illustrate example E-field profile simulation results 220 and example E-field profile simulation results 230, respectively, in accordance with some embodiments of the present disclosure. The example simulation results 220 and the example E-field profile simulation results 230 illustrate the E-field profile of the vertical waveguide at Port 6 and of an adjacent waveguide at Port 6_r, respectively. As illustrated in the example of FIGS. 2C and 2D, the waveguide structure provides for reduced (e.g., minimal) coupling loss between Port 6 and Port 6_r. The simulation results illustrated in FIGS. 2A, 2B, 2C, and 2D are examples of Ansys-Lumerical finite-difference time-domain (FDTD) simulations, which are used to model light propagation through waveguides and nano-mirror couplers.

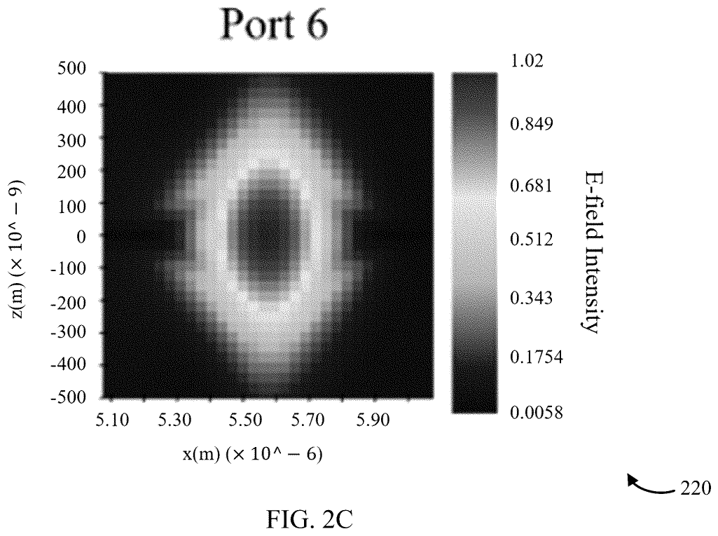

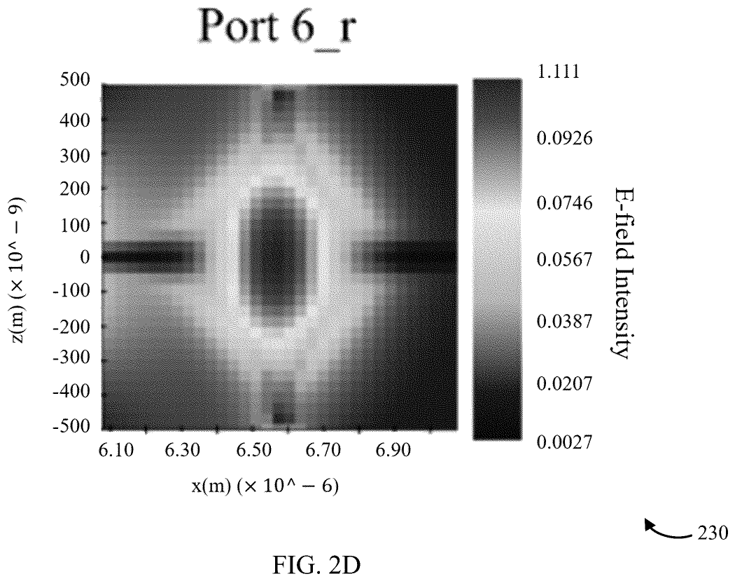

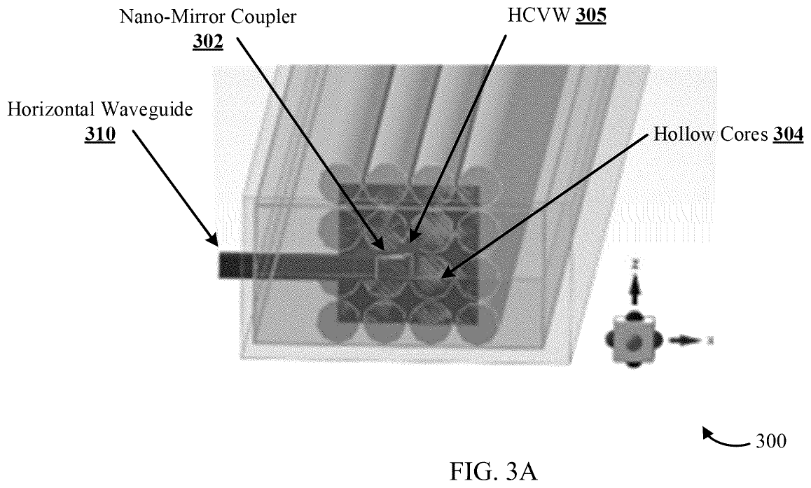

FIG. 3A illustrates an example schematic diagram 300 of an HCVW 305 in accordance with some embodiments of the present disclosure. For example, the HCVW includes hollow cores 304, which may be examples of hollow cores 104 illustrated by and described with reference to FIGS. 1A and 1B. For example, the hollow cores 304 may be integrated into a waveguide structure with a horizontal waveguide 310 and a nano-mirror coupler 302. The horizontal waveguide 310 and the nano-mirror coupler 302 may be examples of the corresponding components illustrated by and described with reference to FIGS. 1A and 1B.

FIG. 3B illustrates an example simulation results 320 in accordance with some embodiments of the present disclosure. As illustrated in the example of FIG. 3B, the hollow cores 304 may be integrated in an HCVW 305 around a vertical waveguide providing an optical path. That is, the vertical waveguide of the HCVW 305 may be configured (e.g., formed) in between the hollow cores 304. In other words, the vertical (or out-of-plane) waveguide of the HCVW 305 provides a star-shaped optical path centered in between the hollow cores 304. The example simulation results 320 illustrate the E-field profile of the HCVW 305 (e.g., the optical path of the HCVW 305) at Port 6 and an adjacent HCVW 307 at Port 6_r. That is, the example simulation results 320 illustrate coupling across ports adjacent (and diagonal) to Port 6. As illustrated in the example of FIG. 3B, the hollow cores 304 provide about a 1 μm-pitch between adjacent optical paths (e.g., between nearby links, such as the HCVW 305 and the HCVW 307), which may lead to low crosstalk. That is, based on a diameter of the hollow cores 304, the distance between the HCVW 305 and the adjacent HCVW 307 is about 1 μm.

FIG. 3C illustrates example E-field cross-section simulation results 330 in accordance with some embodiments of the present disclosure. The example simulation results 330 are for the HCVW 305 illustrated by and described with reference to FIGS. 3A and 3B. That is, the example simulation results 330 illustrate the E-field transfer through the HCVW 305. As illustrated in the examples of FIGS. 3A, 3B, and 3C, the hollow cores 304 may be engineered with large air-filled cores strategically positioned between adjacent vertical waveguides (e.g., between the HCVW 305 and adjacent HCVW 307), thereby reducing optical losses and crosstalk. The simulation results illustrated in FIGS. 3B and 3C are examples of Ansys-Lumerical FDTD simulations, which are used to model light propagation through waveguides and nano-mirror couplers.

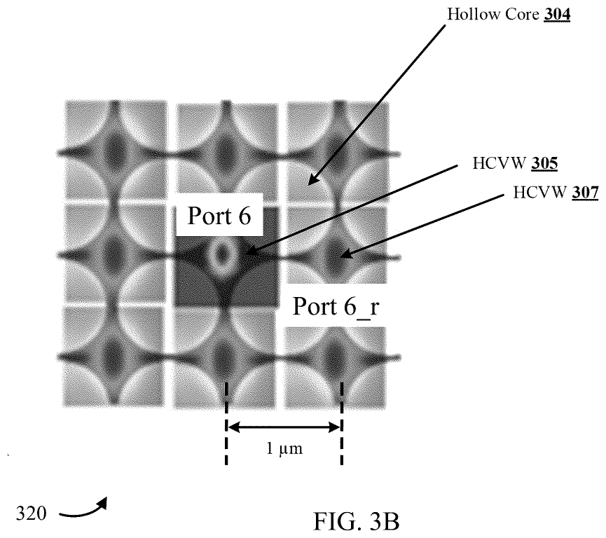

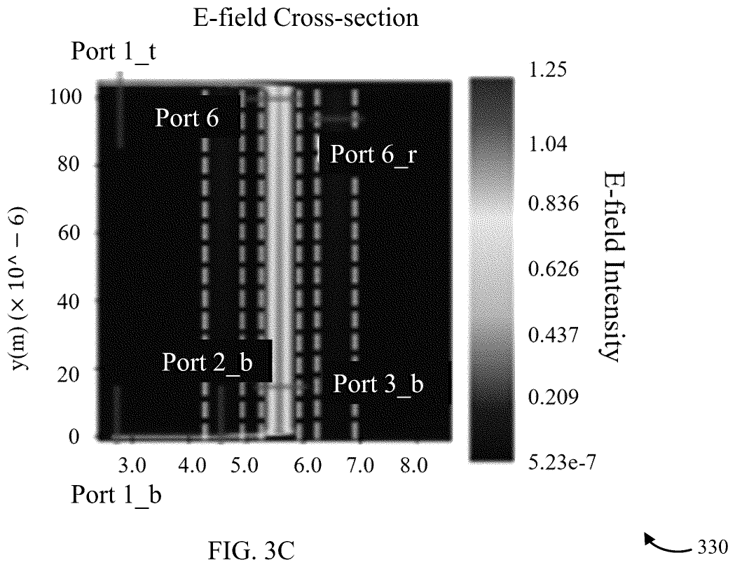

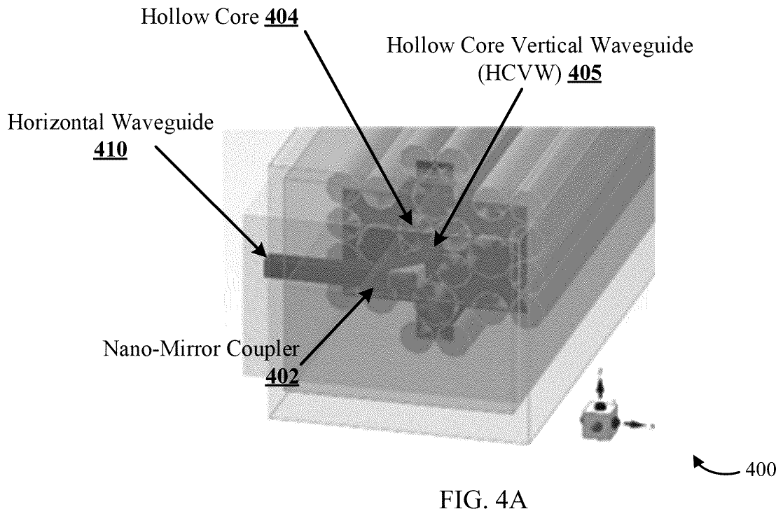

FIG. 4A illustrates an example schematic diagram 400 of an HCVW 405 in accordance with some embodiments of the present disclosure. The HCVW 405 includes hollow cores 404, which may be examples of hollow cores 104 illustrated by and described with reference to FIGS. 1A and 1B. For example, the hollow cores 404 may be integrated into a waveguide structure with a horizontal waveguide 410 and a nano-mirror coupler 402. The horizontal waveguide 410 and the nano-mirror coupler 402 may be examples of the corresponding components illustrated by and described with reference to FIGS. 1A and 1B.

FIG. 4B illustrates an example simulation results 420 in accordance with some embodiments of the present disclosure. The example simulation results 420 illustrate the E-field profile of the HCVW 405 at Port 6 and an adjacent HCVW 407 e at Port 6_r. That is, the example simulation results 420 illustrate coupling across ports adjacent (and diagonal) to Port 6.

As illustrated in the example of FIG. 4B, the hollow cores 404 may be integrated in an HCVW 405 around a vertical waveguide (e.g., forming an optical path). That is, a vertical waveguide of the HCVW 405 may be configured (e.g., formed) in between the hollow cores 404. As illustrated in the example of FIG. 4B, the HCVW 405 may be one of multiple HCVWs within an array. In some examples, the pitch of the array may be based on a diameter of the hollow cores 404. That is, the distance between two adjacent HCVWs waveguides (e.g., the HCVW 405 and adjacent HCVW 407) of an array may be based on a diameter of one or more types of hollow cores integrated in the array. For example, the array illustrated in the example of FIG. 4B may include the hollow cores 404 (positioned around the respective optical path of HCVW 405 and adjacent HCVW 407) and hollow cores 406 positioned in between two adjacent HCVWs (e.g., between the HCVW 405 and adjacent HCVW 407). In the example of FIG. 4B, the hollow cores 404 have a diameter of about 0.96 μm and the hollow cores 406 have a diameter of about 1.08 μm. As such, the pitch of the array is about 3 μm. That is, the distance between the HCVW 405 and adjacent HCVW 407 is about 3 μm. In other words, the hollow cores 404 and the hollow cores 406 provide about a 3 μm-pitch between adjacent waveguides (e.g., between nearby links), which may lead to ultra-low crosstalk.

FIG. 4C illustrates example E-field cross-section simulation results 430 in accordance with some embodiments of the present disclosure. The example simulation results 430 are for a portion of the waveguide structure illustrated by and described with reference to FIGS. 4A and 4B. The example simulation results 430 illustrate the E-field transfer through the HCVW 405. As illustrated in the examples of FIGS. 4A, 4B, and 4C, the hollow cores 404 may be engineered with large air-filled cores strategically positioned between adjacent optical paths (e.g., waveguides), thereby reducing optical losses and crosstalk. The simulation results illustrated in FIGS. 4B and 4C are examples of Ansys-Lumerical FDTD simulations, which are used to model light propagation through waveguides and nano-mirror couplers.

Various aspects of the present disclosure leverage a combination of high-performance materials to improve (e.g., optimize) light confinement and reduce (e.g., minimize) optical losses. Horizontal waveguides may be constructed using materials such as Si, SiNx, III-V semiconductors, one or more oxides, or one or more polymers. In some examples, one or more materials may be chosen for the horizontal waveguides based on the one or more materials having low-loss propagation and compatibility with one or more fabrication techniques, such as IBE, grayscale lithography, and or chemical vapor deposition (CVD), among other examples of advanced fabrication techniques. In some examples, HCVWs may be fabricated from crystalline Si, which offers suitable light confinement, mechanical stability, and the ability to integrate with horizontal waveguides. The hollow core design of the waveguide structure may incorporate relatively large air-filled gaps between adjacent optical paths to reduce crosstalk (e.g., even for closely spaced waveguides with pitches as small as 3 μm). The hollow core design provides mode matching and reduced (e.g., minimized) modal overlap, enhancing coupling efficiency.

In some examples, the waveguide structure may integrate concave and/or flat nano-mirror couplers at the intersection of horizontal and vertical waveguides. For example, the waveguide structure may integrate concave mirrors engineered to focus light and/or flat mirrors engineered to facilitate efficient reflection. One or more design parameters for the nano-mirror couplers include curvature radius, tilt angle, diameter, and alignment precision. The one or more design parameters may be modified (e.g., optimized) to increase (e.g., maximize) coupling efficiency and reduce (e.g., minimize) the device footprint. As such, the nano-mirror couplers may be suitable for high-density photonic circuits. The nano-mirror couplers may be positioned with sub-micron alignment accuracy to reduce (e.g., minimize) insertion loss and increase (e.g., maximum) optical stability.

Simulation results, such as those described herein, may be obtained using one or more simulation tools, such as Ansys-Lumerical FDTD simulations, to model light propagation through the waveguides and nano-mirror couplers. In some examples, iterative adjustments may be made to the designs based on simulation and experimental feedback. By iteratively adjusting the design, the geometry of the HCVWs, the configuration of the nano-mirror couplers, and the integration of the waveguides may be refined, thereby achieving improved coupling performance. In some examples, broadband performance, insertion loss, and crosstalk may be analyzed to determine whether a device including the waveguide structure satisfies stringent constraints of 3D photonic routing fabrics.

The fabrication of HCVWs and/or nano-mirror couplers may involve one or more techniques to ensure precision and reliability. For example, to form the HCVWs, vertical waveguides may incorporate air-filled cores to isolate adjacent optical paths and reduce (e.g., minimize) crosstalk. High-precision etching techniques may be employed to define the core structures of the HCVWs, providing relatively high geometric accuracy and mechanical stability.

In some examples, one or more nano-mirror couplers may include flat mirrors. In some such examples, the flat mirrors may be fabricated using IBE (e.g., at 45-degree tilts) on crystalline Si substrates. Cavities formed from the IBE may be metallized using materials compatible with complementary metal-oxide-semiconductors (CMOS). That is, the cavities may be metalized using CMOS-compatible materials, such as AI for cost-effectiveness or Au/Ag to achieve lower optical losses. In some examples, the material used to metalize the cavities depends on application tolerances.

Additionally, or alternatively, one or more nano-mirror couplers may include concave mirrors. In some such examples, the concave mirrors may be formed using one or more grayscale lithography techniques, which may employ photon or electron beams. For example, photon or electron beams may be used to shape concave mirrors with relatively high precision. The concave mirrors may be coated with amorphous Si, for example, to achieve enhanced optical properties.

In some examples, vertical waveguide deposition may include one or more CVD techniques. For example, the vertical waveguides may be formed using low-pressure chemical vapor deposition (LPCVD) for high-quality a-Si layering. Horizontal and vertical waveguides may be fabricated with deep etching and/or hybrid bonding techniques for relatively strong interlayer integration. In some examples, high-precision foundry techniques, such as those available at NIST Gaithersburg, may be utilized to manufacture components with sub-micron accuracy.

Various characterization methods may be employed to validate the performance of the fabricated devices, including optical characterization, microscopy and imaging techniques, and benchmarking. The optical characterization may include fiber-based coupling setups, on-chip grating couplers, lasers, and photo detectors to measure coupling efficiency and insertion loss. The microscopy and imaging techniques may include scanning electron microscopy (SEM), focused ion beam (FIB) and atomic force microscopy (AMF) imaging to analyze the surface profile, roughness, and alignment accuracy of the HCVWs, nano-mirror couplers, and waveguides (e.g., horizontal waveguides, vertical waveguides). The benchmarking may include comparative studies demonstrating various advantages of various techniques described herein, including improvements in coupling efficiency, reduced footprint, and lower optical losses over traditional methods.

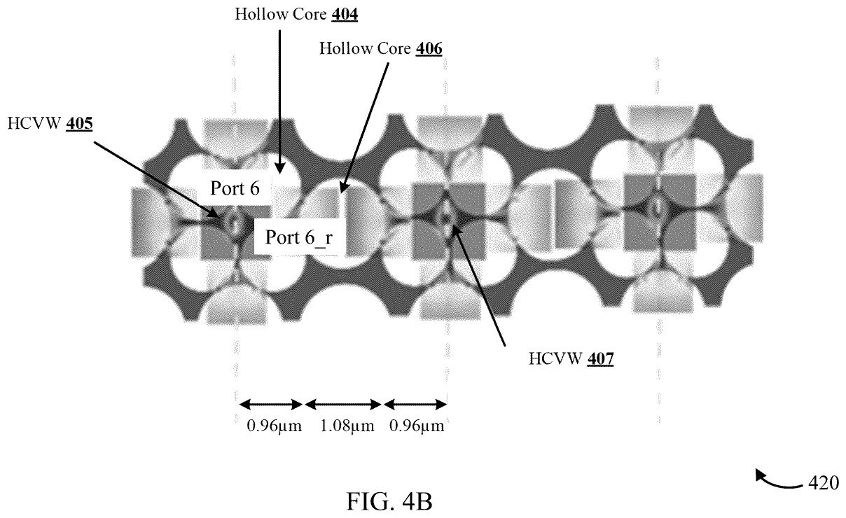

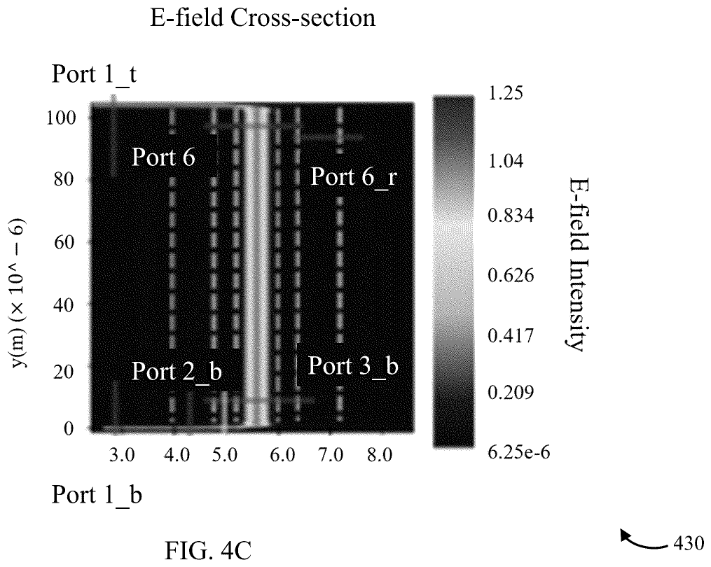

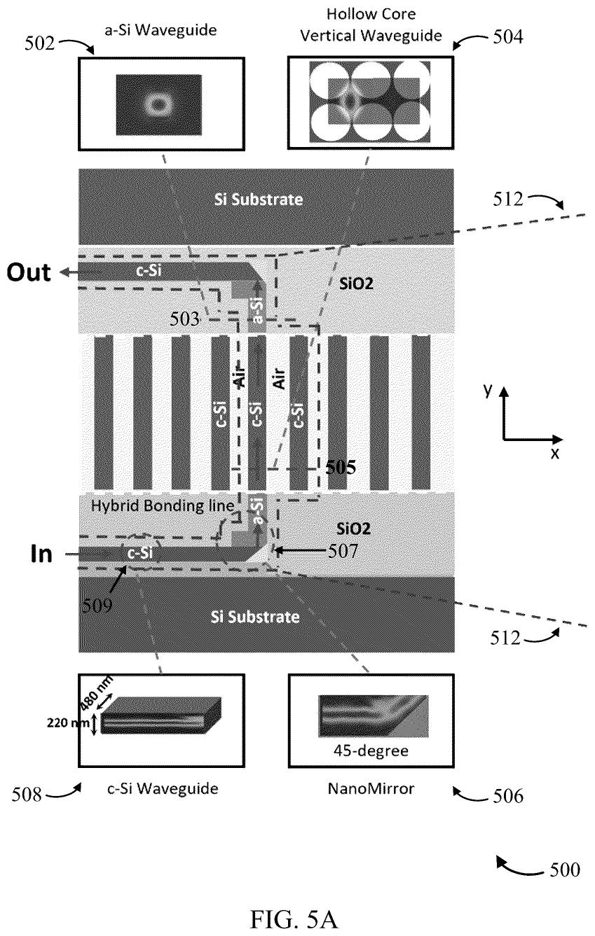

FIGS. 5A-C illustrate a schematic and simulation results of HCVWs integrated with NMCs. FIG. 5A illustrates an example schematic diagram of a hybrid HCVW structure 500 integrated with NMCs. The waveguide structure 500 includes one or more out-of-plane (vertical) waveguides and one or more in-plane (horizontal) waveguides coupled via NMCs. The waveguide structure 500 may be used in photonic interconnects or routing fabrics. In the example of FIG. 5A, the NMCs include a 450 reflective interface embedded within the silicon substrate. Inset 502 shows E-field profile simulation results of an out-of-plane α-Si waveguide at 503. The out-of-plane α-Si waveguide may be an example of a vertical waveguide 108 illustrated by and described with reference to FIGS. 1A-B. Inset 504 shows E-field profile simulation results for the HCVW at 505. Inset 506 shows E-field simulation results for an NMC at 507. The NMC may be an example of an NMC 102 illustrated by and described with reference to FIGS. 1A-B. Inset 508 shows E-field simulation results for an in-plane c-Si waveguide at 509, in which the in-plane c-Si waveguide is 220 nm in the y-dimension and 480 nm in the z-dimension. The in-plane c-Si waveguide may be an example of a horizontal waveguide 110 illustrated by and described with reference to FIGS. 1A-B.

FIG. 5B illustrates example E-field cross-section simulation results 510 in accordance with some embodiments of the present disclosure. FIG. 5B shows example E-field simulation results of the area of the hybrid HCVW structure 500 denoted by dashed lines 512. The E-field lateral cross-section shown in FIG. 5B is obtained at 1550 nm, showing efficient mode confinement with minimal insertion loss. At Ports 7 (right side) and 6 (left side), vertical propagation with low crosstalk is demonstrated. The inset of FIG. 5B shows the localized field intensity near the waveguide core, corresponding to section 513. FIG. 5C illustrates an example 3D schematic diagram of the hybrid HCVW structure 500 integrated with NMCs.

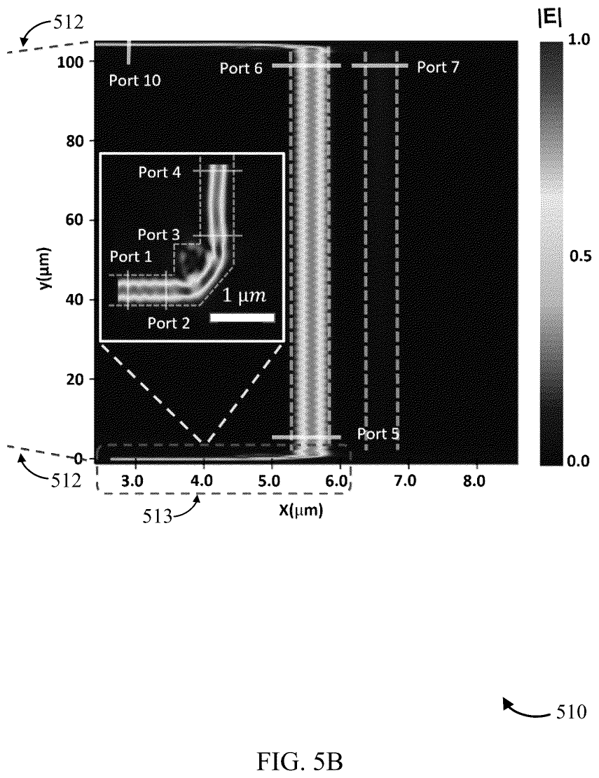

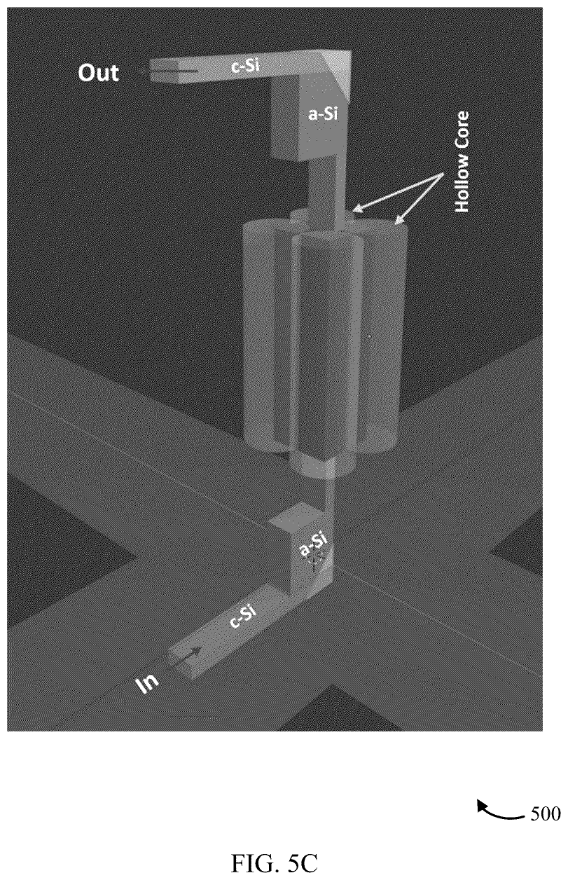

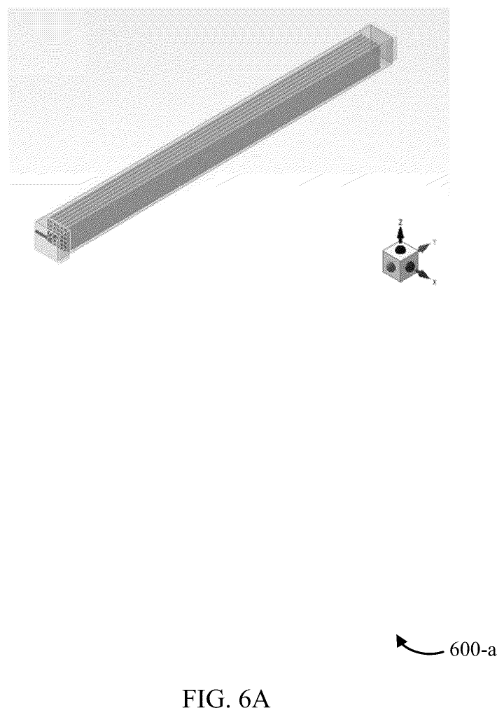

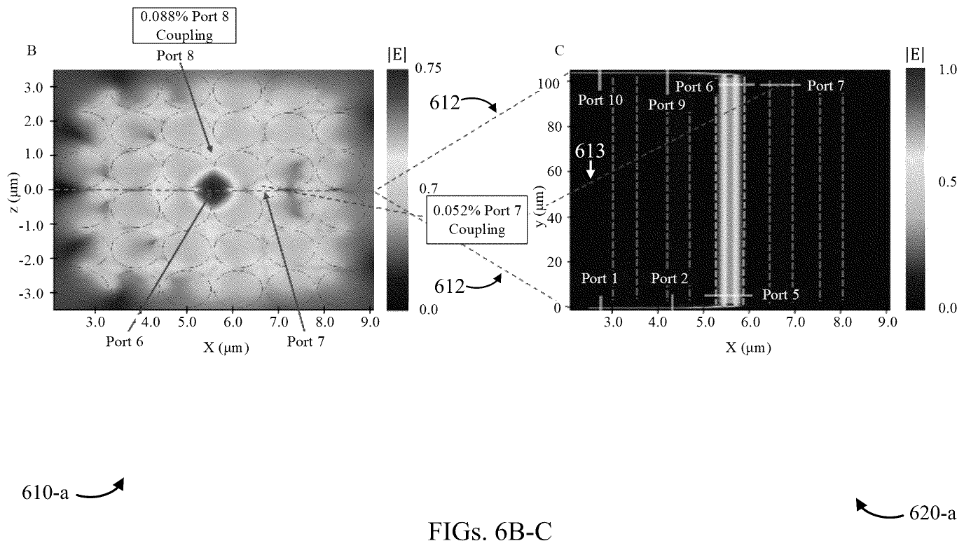

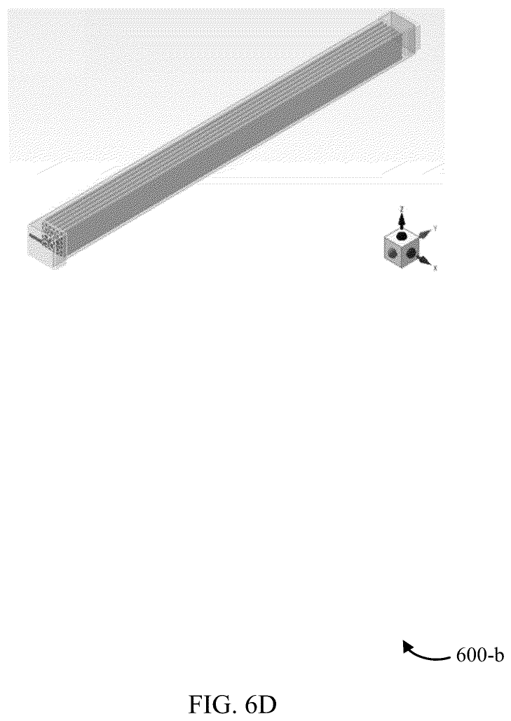

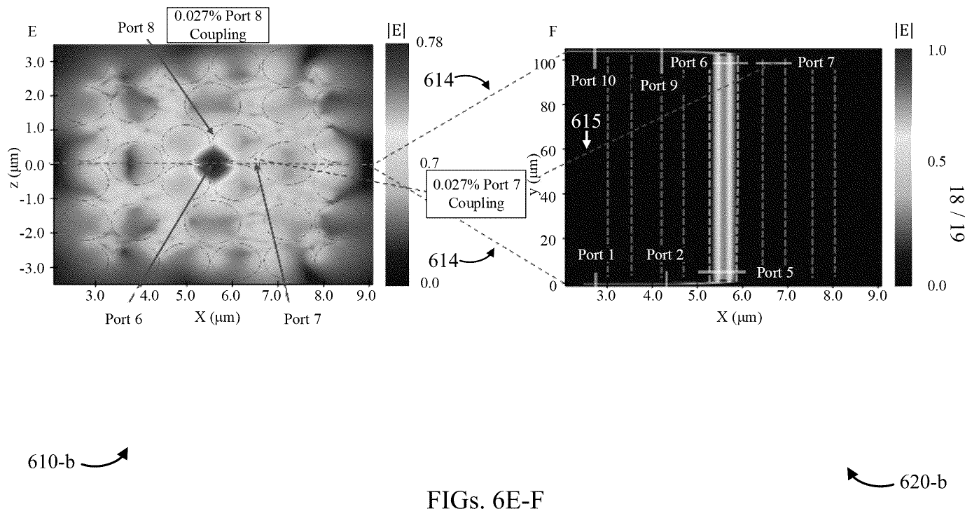

FIGS. 6A-F illustrate 3D visualizations and mode analyses of integrated HCVW architectures. FIGS. 6A-C correspond to a symmetric case in which the structures of the HCVWs (e.g., all of the HCVWs), including the central hollow (air) core, are substantially the same (e.g., the HCVWs are structurally identical or nearly identical). FIGS. 6D-F correspond to an isolated case in which asymmetry is introduced in the surrounding HCVWs while keeping the central hollow core unchanged relative to the symmetric case.

FIG. 6A illustrates an example 3D schematic diagram of an integrated HCVW architecture 600-a in accordance with some embodiments of the present disclosure. The 3D schematic diagram of FIG. 6A shows, for the symmetric case, a perspective view of the symmetric HCVW system with integrated NMCs. In the example of FIG. 6A, light propagates laterally along the x-axis and vertically through the hollow core along the y-axis. FIG. 6B illustrates example simulation results 610-a in accordance with some embodiments of the present disclosure. In the example of FIG. 6B, Port 6 shows confined mode coupling, with 0.052% right side coupling (port 7) and 0.088% top side coupling (port 8). FIG. 6C illustrates example E-field cross-section simulation results 620-a in accordance with some embodiments of the present disclosure. In the example of FIG. 6C, the E-field cross-section simulation results 620-a are obtained from the portion indicated by dashed lines 612, and the lateral cross-section of the hybrid device (port1 to port10) exhibits vertical optical transfer. The dashed line 613 indicates the light path and demonstrates that low-crosstalk vertical coupling is achieved.

FIG. 6D illustrates an example 3D schematic diagram of an integrated HCVW architecture 600-b in accordance with some embodiments of the present disclosure. The 3D schematic diagram of FIG. 6D shows an isometric view of the isolated HCVW structure with an air-filled core, configured (e.g., optimized) for crosstalk reduction in dense 3D photonic integration. FIG. 6E illustrates example simulation results 610-b in accordance with some embodiments of the present disclosure. In the example of FIG. 6E, the E-field profile at port 6 shows strong mode confinement, with diagonal coupling reduced to 0.027% (port 7) and 0.027% (port 8). FIG. 6F illustrates example E-field cross-section simulation results 620-b in accordance with some embodiments of the present disclosure. In the example of FIG. 6F, the E-field cross-section simulation results 620-b are obtained from the portion indicated by dashed lines 614, and the lateral cross-section confirms efficient vertical routing with minimal inter-channel interference. The dashed line 615 indicates the light path, demonstrating low-crosstalk vertical coupling. Compared to conventional 3×3 photonic interconnects, the integrated coupler designs of the present disclosure achieve higher vertical coupling accuracy and superior crosstalk suppression.

Table 1 below illustrates transmission (T) and insertion loss (IL) data obtained at 1550 nm for two configurations of the hybrid-integrated photonic routing system (e.g., as shown in FIGS. 6A-F).

TABLE 1

| | T (normalized) | | | IL (dB) | |
|---|---|---|---|---|---|
| | Nominal | Isolated | | Nominal | Isolated |
| Port | case | case | Component Name | case | case |
| T1 | 0.998 | 0.998 | — | — | — |
| T2 | 0.998 | 0.998 | Bottom Horizontal | 0.001 | 0.001 |
| | | | Waveguide | | |
| T3 | 0.974 | 0.974 | Bottom NMC | 0.105 | 0.108 |
| T4 | 0.966 | 0.965 | Bottom Vertical | 0.037 | 0.036 |
| | | | Waveguide | | |
| T5 | 0.947 | 0.957 | Waveguide Coupling | 0.086 | 0.036 |
| T6 | 0.947 | 0.957 | HCVW | 0.001 | 0.000 |
| T7 | 5.2e−4 | 2.7e−4 | Right Side Coupling | −32.854 | −35.710 |
| T8 | 8.8e−4 | 2.7e−4 | Top Side Coupling | −30.470 | −35.671 |
| T9 | 0.926 | 0.940 | Top NMC | 0.094 | 0.082 |
| T10 | 0.919 | 0.931 | Total IL | 0.368 | 0.311 |

The nominal configuration denoted in Table 1 features a symmetric design (FIGS. 6A-C) in which the structures of the HCVWs, including the central air core, are substantially the same (e.g., all HCVWs are structurally identical or nearly identical). In the isolated configuration (FIGS. 6D-F), asymmetry is introduced in the surrounding HCVWs while keeping the central hollow core unchanged relative to the symmetric case. As illustrated in Table 1, by introduced asymmetry into the surrounding HCVWs (while keeping the central hollow core unchanged), cross-coupling was reduced and transmission through the central channel was enhanced.

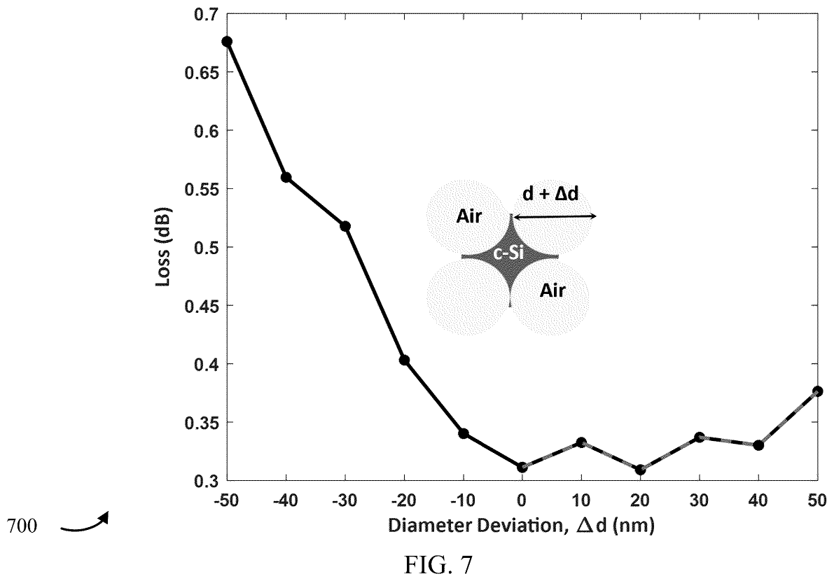

FIG. 7 illustrates an example diagram 700 of a sensitivity analysis of an integrated coupler. As illustrated in FIG. 7, the sensitivity analysis of the integrated coupler shows optical loss as a function of hollow core diameter deviation (±50 nm). Performance reached a maximum at the nominal diameter (0 nm) and decreased with increasing deviations. For example, deviations from 0 nm lead to increasing mismatch and scattering. The inset of FIG. 7 illustrates the vertical hollow-core structure and the deviation in hollow-core diameter (d+Δd).

An isolated HCVW structure with a 560 nm hollow core radius achieved a relatively low insertion loss (e.g., an insertion loss of about 0.001 dB) and crosstalk suppression of −35.71 dB. Increasing or decreasing the core diameter (e.g., deviating from 0 nm) introduces mode mismatch, leading to higher loss, as confirmed by FDTD (finite-difference time-domain) simulations. In contrast, increasing the diameter from 470 nm to 510 nm also leads to fluctuating loss due to air-core overlap. This deviation suggests that optical field symmetry deteriorates with increasing diameter, highlighting that tighter lithographic and deep-etching control may lead to improved performance.

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation. It should be understood that the examples and embodiments in Appendices A and B are also for illustrative purposes and are non-limiting in nature. The contents of Appendices A and B are incorporated herein by reference in their entirety.

1. An apparatus comprising:
an in-plane waveguide;
a hollow-core-vertical-waveguide (HCVW) comprising an out-of-plane waveguide and hollow cores; and
an interface coupled with the in-plane waveguide, wherein the interface is configured to transfer light between the in-plane waveguide and the out-of-plane waveguide.

2. The apparatus of claim 1, wherein the in-plane waveguide is configured for horizontal light propagation and the out-of-plane waveguide is configured for vertical light propagation, and wherein the out-of-plane waveguide is positioned vertically above or below the in-plane waveguide.

3. The apparatus of claim 1, wherein the hollow cores are oriented along the same plane as the out-of-plane waveguide, and wherein the hollow cores are positioned around the out-of-plane waveguide.

4. The apparatus of claim 1, wherein the HCVW is one of a plurality of HCVWs within an array, and wherein the pitch of the array is based at least in part on a diameter of the hollow cores.

5. The apparatus of claim 4, further comprising:
at least one other hollow core positioned in between the HCVW and a second HCVW of the array, wherein the pitch is based at least in part on the diameter of the at least one other hollow core.

6. The apparatus of claim 5, wherein the diameter of the at least one other hollow core is different from the diameter of the hollow cores.

7. The apparatus of claim 4, wherein the pitch is greater than about 1 micron.

8. The apparatus of claim 1, wherein the hollow cores comprise air, silicon oxide, or another material with a refractive index that is lower that the refractive index of the HCVW.

9. The apparatus of claim 1, wherein the in-plane waveguide comprises a material selected from the group consisting of: a crystalline silicon material, a silicon nitride material, a material comprising a group III element and a group V element, an oxide material, a polymer material, and a combination thereof.

10. The apparatus of claim 1, wherein the out-of-plane waveguide comprises a material selected from the group consisting of: an amorphous silicon material, a crystalline silicon material, a silicon nitride material, a material comprising a group III element and a group V element, an oxide material, and a combination thereof.

11. The apparatus of claim 1, wherein the interface comprises a flat surface or a concave surface of the in-plane waveguide.

12. The apparatus of claim 11, wherein an insertion loss and mode alignment associated with the apparatus is based at least in part on an angle of the flat surface or a curvature of the concave surface.

13. The apparatus of claim 1, wherein the interface comprises a reflective layer.

14. The apparatus of claim 13, wherein the interface further comprises an air gap positioned below the reflective layer.

15. The apparatus of claim 1, wherein the apparatus comprises a photonic interconnect or routing fabric.

16. A method for fabricating the apparatus of claim 1 in accordance with a fabrication process, wherein the fabrication process comprises forming the interface in the in-plane waveguide using wet etching, dry etching, or gray scale lithography.

17. The method of claim 16, wherein the fabrication process comprises forming the interface in the in-plane waveguide via the wet etching or the dry etching to obtain a flat surface.

18. The method of claim 16, wherein the fabrication process comprises forming the interface in the in-plane waveguide via the gray scale lithography to obtain a concave surface.

19. The method of claim 16, wherein the fabrication process further comprises fabricating the HCVW via a deep etching process, and wherein the deep etching process comprises dry deep etching or wet deep etching.

20. The method of claim 16, wherein the fabrication process further comprises fabricating the in-plane waveguide via an etching process, and wherein the etching process comprises dry etching or wet etching.
